(19) United States
(12) Patent Application Publication
(10) Pub. No.: US 2004/0002849 A1
(43) Pub. Date: Jan. 1, 2004

(54) System and method for automatic retrieval of example sentences based upon weighted editing distance

(76) Inventor: Ming Zhou, Beijing (CN)

Correspondence Address: John Veldhuis-Kroeze, WESTMAN CHAMPLIN & KELLY, International Centre-Suite 1600, 900 South Second Avenue, Minneapolis, MN, 55402-3319, US

(21) Appl. No.: 10/186,174

(22) Filed: Jun. 28, 2002

(51) Int. Cl. G06F 17/28

(52) U.S. Cl. 704/4

(57) ABSTRACT

A method and computer-readable medium are provided that retrieve example sentences from a collection of sentences. An input query sentence is received, and candidate example sentences for the input query sentence are selected from the collection of sentences using a term frequency-inverse document frequency (TF-IDF) algorithm. The selected candidate example sentences are then re-ranked based upon weighted editing distances between the selected candidate example sentences and the input query sentence. A system which implements the method is also provided.

### BACKGROUND OF THE INVENTION

The present invention relates to machine aided writing systems and methods. In particular, the present invention relates to systems and methods for automatically retrieving example sentences to aid in writing or translation processes.

There are a variety of applications in which the automatic retrieval of example sentences is necessary or beneficial. For instance, in example-based machine translation, it is necessary to retrieve sentences which are syntactically similar with the sentence to be translated. The translation is then obtained by animating or selecting a retrieved sentence.

In a machine assisted translation system, such as a translation memory system, a retrieval method is required to get relevant sentences. However, many retrieval algorithms suffer various kinds of drawbacks, and some of them are not effective. For example, often the sentences retrieved have little relevance with the input sentence. Other problems with many retrieval algorithms include the fact that some of them are not efficient, some of them require significant memory and processing resources, and some of them require pre-annotation to the sentence corpus, which is a terribly time-consuming burden.

Automatic retrieval of example sentences can also be used as a writing aid, for example as a kind of HELP function for a word processor. This can be true whether a user is writing in his or her native language, or in a language which is not native. For example, with an ever increasing global economy, and with the rapid development of the Internet, people all over the world are becoming increasingly familiar with writing in a language which is not their native language. Unfortunately, for some societies that possess significantly different cultures and writing styles, the ability to write in some non-native languages is an ever-present barrier. When writing in a non-native language (for example English), language usage mistakes are frequently made by the non-native speakers (for example, people who speak Chinese, Japanese, Korean or other non-English languages). Retrieval of example sentences provides the writer with examples of sentences having similar content, similar grammatical structure, or both for purposes of helping to polish the sentences generated by the writer.

Consequently, an improved method of, or algorithm for, providing effective example sentence retrieval would be a significant improvement.

### SUMMARY OF THE INVENTION

A method, computer-readable medium and system are provided that retrieve example sentences from a collection of sentences. An input query sentence is received, and candidate example sentences for the input query sentence are selected from the collection of sentences using a term frequency-inverse document frequency (TF-IDF) algorithm. The selected candidate example sentences are then re-ranked based upon weighted editing distances between the selected candidate example sentences and the input query sentence.

Under some embodiments, the selected candidate example sentences are re-ranked as a function of a minimum number of operations required to change each candidate example sentence into the input query sentence. Under other embodiments, the selected candidate example sentences are re-ranked as a function of a minimum number of operations required to change the input query sentence into each of the candidate example sentence.

Under various embodiments, the selected candidate example sentences are re-ranked based upon weighted editing distances between the selected candidate example sentences and the input query sentence. Under some embodiments, re-ranking the selected candidate example sentences based upon weighted editing distances further includes calculating a separate weighted editing distance for each candidate example sentence as a function of terms in the candidate example sentence, and as a function of weighted scores corresponding to the terms in the candidate example sentence. The weighted scores have differing values based upon a part of speech associated with the corresponding terms in the candidate example sentence. The selected candidate example sentences are then re-ranked based upon the calculated separate weighted editing distances for each candidate example sentence.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 is a block diagram illustrating a system, which can be implemented in computing environments such as those shown in FIGS. 1 and 2, for retrieving example sentences and for ranking the example sentences based upon editing distance in accordance with embodiments of the present invention.

FIG. 4 is a block diagram illustrating a method of retrieving example sentences and of ranking the example sentences based upon editing distance in accordance with embodiments of the present invention.

FIG. 5 is a block diagram illustrating a method of retrieving example sentences and of ranking the example sentences based upon editing distance in accordance with further embodiments of the present invention.

### DETAILED DESCRIPTION OF ILLUSTRATIVE EMBODIMENTS

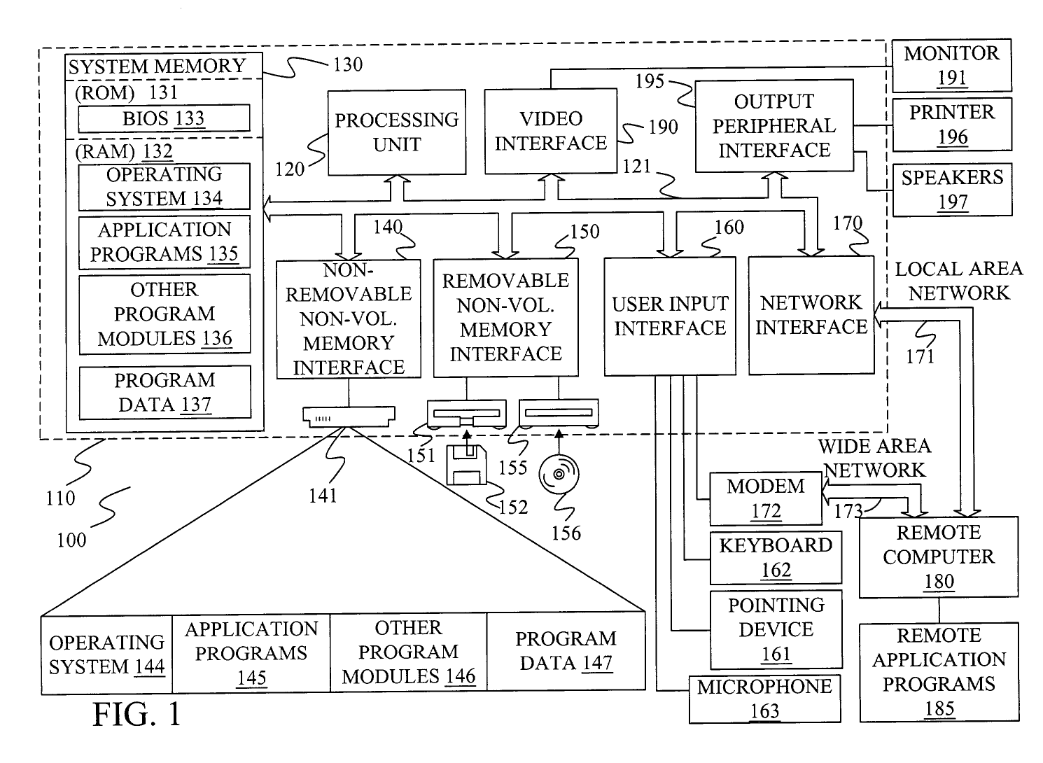

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

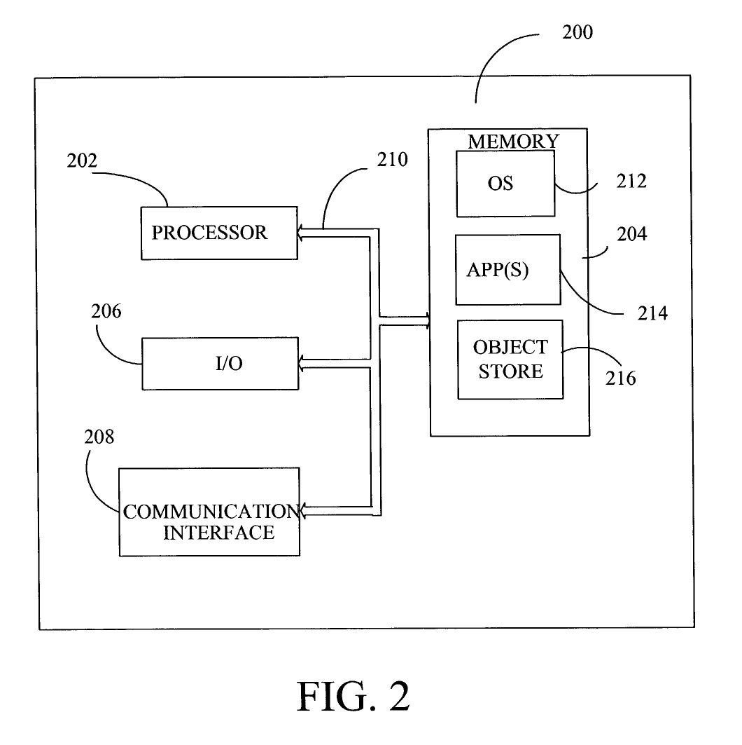

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the aforementioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

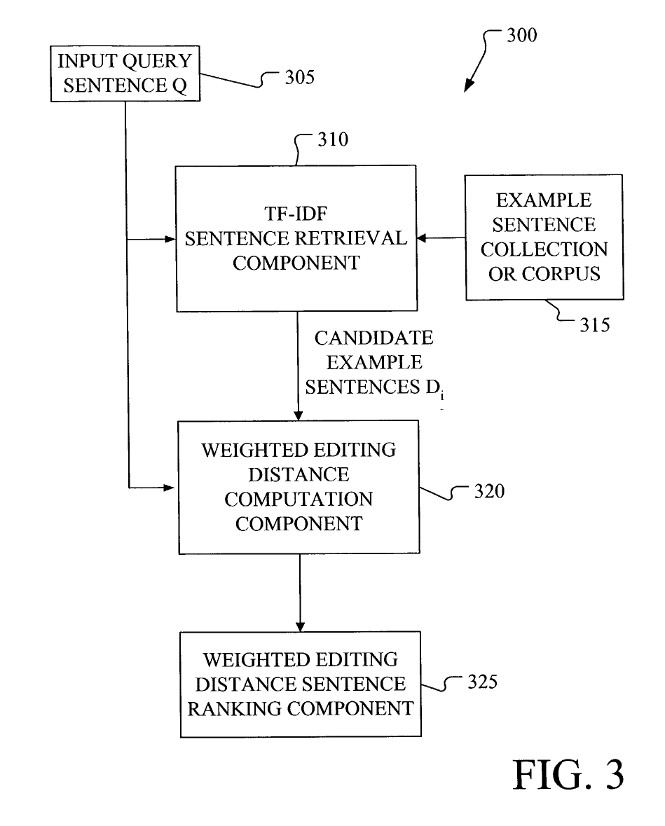

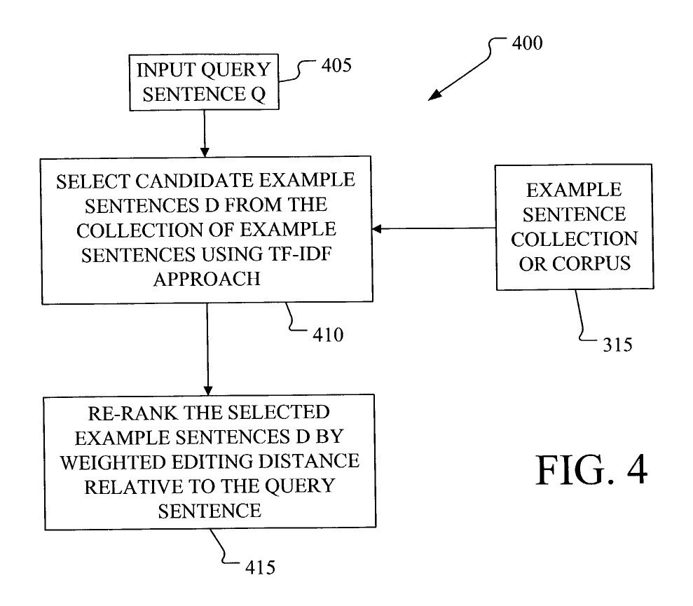

In accordance with various aspects of the present invention, proposed are systems and methods for automatically retrieving example sentences to aid in writing or translation processes. The systems and methods of the present invention can be implemented in the computing environments shown in FIGS. 1 and 2, as well as in other computing environments. An example sentence retrieval algorithm in accordance with the invention includes two steps: selecting the candidate sentences using a weighted term frequency-inverse document frequency (TF-IDF) approach; and ranking the candidate sentences by weighted editing distance. FIG. 3 is a block diagram illustrating a system 300 for implementing the method. FIG. 4 is a block diagram 400 illustrating the general method.

As shown in FIG. 3, a query sentence Q, shown at 305, is input into the system. Based upon query sentence 305, a sentence retrieval component 310 uses a conventional TF-IDF algorithm or method to select candidate example sentences Dᵢ from the collection D of example sentences shown at 315. The corresponding step 405 of inputting the query sentence, and the step 410 of selecting candidate example sentences Dᵢ from the collection D, are shown in FIG. 4. Although TF-IDF approaches are widely used in traditional information retrieval (IR) systems, a discussion of a TF-IDF algorithm used by retrieval component 310 in an exemplary embodiment is provided below.

After sentence retrieval component 310 selects the candidate example sentences from the collection 315, weighted editing distance computation component 320 generates a weighted editing distance for each of the candidate example sentences. As is described below in greater detail, the editing distance between one of the candidate example sentences and the input query sentence is defined as the minimum number of operations required to change the candidate example sentence into the query sentence. In accordance with the invention, different parts of speech (POS) are assigned different weights or scores during computation of the editing distance. A ranking component 325 re-ranks the candidate example sentences in order of editing distance, with the example sentence having the lowest editing distance value being ranked highest. The corresponding step of re-ranking the selected or candidate example sentences by weighted editing distance is shown in FIG. 4 at 415. This step can include the sub-step of generating or computing the weighted editing distances.

1. Selecting Candidate Sentences with TF-IDF Approach

As described above with reference to FIGS. 3 and 4, candidate sentences are selected from a collection of sentences using a TF-IDF approach which is common in the IR systems. The following discussion provides an example of a TF-IDF approach which can be used by component 310 shown in FIG. 3, and as step 410 shown in FIG. 4. Other TF-IDF approaches can be used as well.

The whole collection 315 of example sentences denoted as D consists of a number of “documents,” with each document actually being an example sentence. The indexing result for a document (which contains only one sentence) with a conventional IR indexing approach can be represented as a vector of weights as shown in Equation 1:

Dᵢ→(dᵢ₁, dᵢ₂, . . . , dᵢₘ) Equation 1

where dᵢₖ (1≦k≦m) is the weight of the term tₖ in the document Dᵢ, and m is the size of the vector space, which is determined by the number of different terms found in the collection. In an example embodiment, terms are English words. The weight dᵢₖ of a term in a document is calculated according to its occurrence frequency in the document (tf—term frequency), as well as its distribution in the entire collection (idf—inverse document frequency). There are multiple methods of calculating and defining the weight dᵢₖ of a term. Here, by way of example, we use the relationship shown in Equation 2:

$${d}_{ik} = \frac{[ log ( {f}_{ik} ) + 1.0 ] * log ( N / {n}_{k} )}{\sqrt{{\sum }_{j }^{} {[ ( log ( {f}_{jk} ) + 1.0 ) * log ( N / {n}_{k} ) ]}^{2}}} \qquad \underline{Equation 2}$$

where fᵢₖ is the occurrence frequency of the term tₖ in the document Dᵢ, N is the total number of documents in the collection, and nₖ is the number of documents that contain the term tₖ. This is one of the most commonly used TF-IDF weighting schemes in IR.

As is also common in TF-IDF weighting schemes, the query Q, which is the user's input sentence, is indexed in a similar way, and a vector is also obtained for a query as shown in Equation 3:

Qⱼ→(qⱼ₁, qⱼ₂, . . . , qⱼₘ) Equation 3

Where the vector weights qⱼₘ (1≦k≦m) for query Qⱼ can be determined using an Equation 2 type of relationship.

The similarity Sim(Dᵢ, Qⱼ) between a document (sentence) Dᵢ in the collection of documents and the query sentence Qⱼ is calculated as the inner product of their vectors, as shown in Equation 4:

$$Sim ( {D}_{i} , {Q}_{j} ) = {\sum }_{k}^{} ( {d}_{ik} * {q}_{jk} ) \qquad \underline{Equation 4}$$

The output is a set of sentences S, where S is defined as shown in Equation 5:

S={Dᵢ|Sim(Dᵢ,Qⱼ)≧δ} Equation 5

2. Re-Ranking the Set of Sentences S by Weighted Edit Distance

As described above with reference to FIGS. 3 and 4, the set S of candidate sentences selected from the collection are re-ranked from shortest editing distance to longest editing distance relative to the input query sentence Q. The following discussion provides an example of an editing distance computation algorithm which can be used by component 320 shown in FIG. 3, and in step 415 shown in FIG. 4. Other editing distance computation approaches can be used as well.

As discussed, a weighted editing distance approach is used to re-rank the selected sentence set S. Given a selected sentence Dᵢ→(dᵢ₁, dᵢ₂, . . . , dᵢₘ) in sentence set S, the edit distance between Dᵢ and Qⱼ, denoted as ED(Dᵢ,Qⱼ), is defined as the minimum number of insertions, deletions and replacements of terms necessary to make two strings A and B equal. The edit distance, which is also sometimes referred to as a Levenshtein distance (LD), is a measure of the similarity between two strings, a source string and a target string. The distance represents the number of deletions, insertions, or substitutions required to transform the source string into the target string.

Specifically, ED(Dᵢ,Qⱼ) is defined as the minimum number of operations required to change Dᵢ into Qⱼ, where an operation is one of:

1. changing a term;

2. inserting a term; or

3. deleting a term.

However, an alternate definition of the editing distance which can be used in accordance with the present invention is the minimum number of operations required to change Qⱼ into Dᵢ.

A dynamic programming algorithm is used to compute the edit distance of two strings. Using the dynamic programming algorithm, a two-dimensional matrix, m[i,j] for i between 0 and |S1| (where |S1| is the number of terms in a first candidate sentence) and j between 0 and |S2| (where |S2| is the number of terms in the query sentence) is used to hold the edit distance values. The two-dimensional matrix can also be denoted as m[0 . . . |S1|, 0, . . . |S2|]. The dynamic programming algorithm defines the edit distance values m[i,j] contained therein using a method such as the one described in the following pseudocode:

$$\begin{matrix}\begin{matrix}m [ i , j ] = ED ( S1 [ 1 …i ] , S2 [ 1 …j ] ) \\ m [ 0 , 0 ] = 0 \\ m [ i , 0 ] = i , i = 1 … \vert S1 \vert \\ m [ 0 , j ] = j , j = 1 … \vert S2 \vert\end{matrix} \\ \begin{matrix}m [ i , j ] = min ( m [ i - 1 , j - 1 ] + \\ if S1 [ i ] = S2 [ j ] then 0 else 1 , \\ m [ i - 1 , j ] + 1 , \\ m [ i , j - 1 ] + 1 ) , i = 1 … \vert S1 \vert , j = 1 … \vert S2 \vert\end{matrix}\end{matrix}$$

The edit distance values of m[,] can be computed row by row. Row m[i,] depends only on row m[i−1,]. The time complexity of this algorithm is O(|s1|*|s2|). If s1 and s2 have a “similar” length in terms of number of terms, for example about “n”, this complexity is O(n²) . The weighted edit distance used in accordance with the present invention is that the penalty of each operation (insert, delete, or substitute) is not always equal to 1 as has been the case in conventional edit distance computation techniques, but instead the penalty can be set to different scores based upon the significance of the terms. For example, the algorithm above can be modified to use a score list according to the part-or-speech as follows in Table 1.

TABLE 1

| POS | Score |
|---|---|
| Noun | 0.6 |
| Verb | 1.0 |
| Adjective | 0.8 |
| Adverb | 0.8 |
| Preposition | 0.8 |
| Others | 0.4 |

Thus, the algorithm can be revised to take into account the parts of speech of terms in question as follows:

$$\begin{matrix}\begin{matrix}m [ i , j ] = ED ( S1 [ 1 …i ] , S2 [ 1 …j ] ) \\ m [ 0 , 0 ] = 0 \\ m [ i , 0 ] = i , i = 1 … \vert S1 \vert \\ m [ 0 , j ] = j , j = 1 … \vert S2 \vert\end{matrix} \\ \begin{matrix}m [ i , j ] = min ( m [ i - 1 , j - 1 ] + \\ if S1 [ i ] = S2 [ j ] then 0 else [ score ] , \\ m [ i - 1 , j ] + [ score ] , \\ m [ i , j - 1 ] + [ score ] ) , \\ i = 1 … \vert S1 \vert , j = 1 … \vert S2 \vert\end{matrix}\end{matrix}$$

For example, at some state of the algorithm, for a noun word, if there is a need to do any operation (insert, deletion), then the score will be 06.

The computation of edit distance of S1 and S2 is a recursive process. To calculate ED(S1[1 . . . i],S2[1 . . . j]), we need the minimum from the following three cases:

1) Both S1 and S2 cut a tail word (or other edit unit)—denoted in the matrix as m[i−1,j−1]+score;

2) Only S1 cut a word, S2 is kept—denoted as m[i−1,j]+score;

3) Only s2 cut a word, S1 is kept—denoted as m[i,j−1]+score;

For case 1, the score can be computed as:

If the tail word of S1 and S2 are same, then score=0;

Otherwise, score=1; (cost is one operation)//in the weighted ED, the score is changeable, see the abovementioned table, noun will be 0.6 for instance.

As mentioned, to compute the recursive process, a method called “dynamic programming” can be used.

Although particular POS scores are shown, the scores for the different parts of speech can be changed in different applications from those shown in Table 1 in other embodiments. Therefore, the sentences S={Dᵢ|Sim(Dᵢ,Qⱼ)≧δ} selected by the TF-IDF approach will be ranked by the weighted edit distance ED, and a ordered list T can be obtained:

T={T₁,T₂,T₃, . . . Tₙ}.

Where, ED(Tᵢ,Qⱼ)≧ED(Tᵢ₊₁,Qⱼ).

1≦i≦n

where T₁ through Tₙ are the candidate example sentences (also referred to previously as D₁ through Dₙ) and ED(Tᵢ,Qⱼ) is the computed edit distance between a sentence T₁ and the input query sentence Qⱼ.

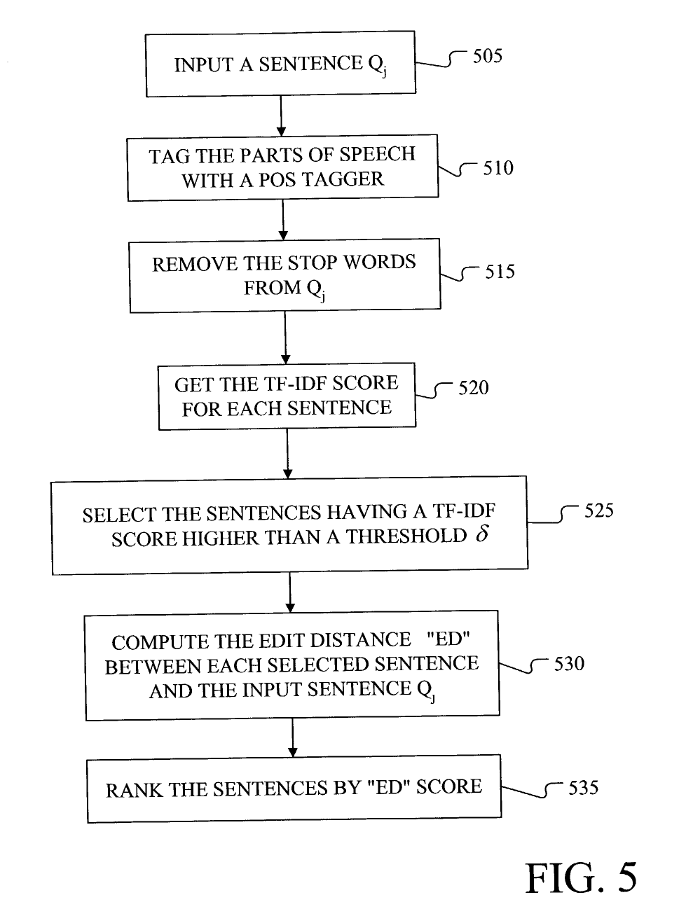

Another embodiment of the general system and method shown in FIG. 4 is shown in the block diagram of FIG. 5. As shown at 505 in FIG. 5, an input sentence Qⱼ is provided to the system as a query. At 510, the parts of speech of the query sentence Qⱼ are tagged using a POS tagger of the type known in the art, and at 515 the stop words are removed from Qⱼ. Stop words are known in the information retrieval field to be words which do not contain much information for information retrieval purposes. These words are typically high frequency occurrence words such as “is”, “he”, “you”, “to”, “a”, “the”, “an”, etc. Removing them can improve the space requirements and efficiency of the program.

As shown at 520, the TF-IDF score for each sentence in the sentence collection is obtained as described above or in a similar manner. The sentences having a TF-IDF score which exceeds a threshold δ are selected as candidate example sentences for use in refining or polishing the input query sentence Q, or for use in a machine assisted translation process. This is shown at block 525. Then, the selected candidate example sentences are re-ranked as discussed previously. In FIG. 5, this is illustrated at 530 as computing the edit distance “ED” between each selected sentence and the input sentence, and at 535 by ranking the candidate sentences by “ED” score.

Although the present invention has been described with reference to particular embodiments, workers skilled in the art will recognize that changes may be made in form and detail without departing from the spirit and scope of the invention. For example, the specific Tf-IDF algorithm shown by way of example in the present application can be altered or replaced with similar algorithms of the type known in the art. Likewise, in re-ranking the selected sentences based upon a weighted editing distance, algorithms other than the one provided as an example can be used.

What is claimed is:

1. A method of retrieving example sentences from a collection of sentences, the method comprising:
receiving an input query sentence;
selecting candidate example sentences for the input query sentence from the collection of sentences using a term frequency-inverse document frequency (TF-IDF) algorithm; and
re-ranking the selected candidate example sentences based upon editing distances between the selected candidate example sentences and the input query sentence.

2. The method of claim 1, wherein re-ranking the selected candidate example sentences further comprises re-ranking the selected candidate example sentences as a function of a minimum number of operations required to change each candidate example sentence into the input query sentence.

3. The method of claim 1, wherein re-ranking the selected candidate example sentences further comprises re-ranking the selected candidate example sentences as a function of a minimum number of operations required to change the input query sentence into each of the candidate example sentence.

4. The method of claim 1, wherein re-ranking the selected candidate example sentences further comprises re-ranking the selected candidate example sentences based upon weighted editing distances between the selected candidate example sentences and the input query sentence.

5. The method of claim 4, wherein re-ranking the selected candidate example sentences based upon weighted editing distances further comprises:
calculating a separate weighted editing distance for each candidate example sentence as a function of terms in the candidate example sentence, and as a function of weighted scores corresponding to the terms in the candidate example sentence, wherein the weighted scores have differing values based upon a part of speech associated with the corresponding terms in the candidate example sentence; and
re-ranking the selected candidate example sentences based upon the calculated separate weighted editing distances for each candidate example sentence.

6. The method of claim 5, wherein selecting candidate example sentences for the input query sentence from the collection of sentences using the TF-IDF algorithm further comprises:
tagging parts of speech associated with corresponding terms in sentences of the collection of sentences;
removing stop words from the input query sentence; and
calculating TF-IDF scores for each sentence of the collection of sentences.

7. The method of claim 6, wherein selecting candidate example sentences for the input query sentence from the collection of sentences using the TF-IDF algorithm further comprises selecting as the candidate example sentences those sentences of the collection of sentences which have a TF-IDF score greater than a threshold.

8. A computer-readable medium having computer-executable instructions for performing steps comprising:
receiving an input query sentence;
selecting candidate example sentences for the input query sentence from a collection of sentences using a TF-IDF algorithm; and
re-ranking the selected candidate example sentences based upon editing distances between the selected candidate example sentences and the input query sentence.

9. The computer readable medium of claim 8, wherein re-ranking the selected candidate example sentences further comprises re-ranking the selected candidate example sentences as a function of a minimum number of operations required to change each candidate example sentence into the input query sentence.

10. The computer readable medium of claim 8, wherein re-ranking the selected candidate example sentences further comprises re-ranking the selected candidate example sentences as a function of a minimum number of operations required to change the input query sentence into each of the candidate example sentence.

11. The computer readable medium of claim 8, wherein re-ranking the selected candidate example sentences further comprises re-ranking the selected candidate example sentences based upon weighted editing distances between the selected candidate example sentences and the input query sentence.

12. The computer readable medium of claim 11, wherein re-ranking the selected candidate example sentences based upon weighted editing distances further comprises:
calculating a separate weighted editing distance for each candidate example sentence as a function of terms in the candidate example sentence, and as a function of weighted scores corresponding to the terms in the candidate example sentence, wherein the weighted scores have differing values based upon a part of speech associated with the corresponding terms in the candidate example sentence; and
re-ranking the selected candidate example sentences based upon the calculated separate weighted editing distances for each candidate example sentence.

13. The computer readable medium of claim 12, wherein selecting candidate example sentences for the input query sentence from the collection of sentences using the TF-IDF algorithm further comprises:
tagging parts of speech associated with corresponding terms in sentences of the collection of sentences;
removing stop words from the input query sentence; and
calculating TF-IDF scores for each sentence of the collection of sentences.

14. The computer readable medium of claim 13, wherein selecting candidate example sentences for the input query sentence from the collection of sentences using the TF-IDF algorithm further comprises selecting as the candidate example sentences those sentences of the collection of sentences which have a TF-IDF score greater than a threshold.

15. A system for retrieving example sentences from a collection of sentences, the system comprising:
an input which receives a query sentence;
a term frequency-inverse document frequency (TF-IDF) sentence retrieval component coupled to the input which selects candidate example sentences for the query sentence from the collection of sentences using a TF-IDF algorithm;
a weighted editing distance computation component, coupled to the TF-IDF component, which calculates a separate weighted editing distance for each selected candidate example sentence as a function of terms in the candidate example sentence, and as a function of weighted scores corresponding to the terms in the candidate example sentence, wherein the weighted scores have differing values based upon a part of speech associated with the corresponding terms in the candidate example sentence; and
a ranking component, coupled to the weighted editing distance computation component, which ranks the selected candidate example sentences based upon the calculated separate weighted editing distances for each candidate example sentence.
